(19) United States
(12) Patent Application Publication
(10) Pub. No.: US 2025/0334952 A1
(43) Pub. Date: Oct. 30, 2025

(54) NUMERICAL CONTROL DEVICE AND COMPUTER-READABLE STORAGE MEDIUM

(71) Applicant: Fanuc Corporation, Minamitsuru-gun, Yamanashi (JP)

(72) Inventor: Shouki TANI, Minamitsuru-gun, Yamanashi (JP)

(73) Assignee: Fanuc Corporation, Minamitsuru-gun, Yamanashi (JP)

(21) Appl. No.: 18/866,656

(22) PCT Filed: May 26, 2022
(86) PCT No.: PCT/JP2022/021555

§ 371 Date: Nov. 18, 2024

(51) Int. Cl. G05B 19/4155; G01B 5/008

(52) U.S. Cl. CPC G05B 19/4155; G01B 5/008; G05B 2219/37457

(57) ABSTRACT

This numerical control device is provided with: a first acquisition unit that acquires start position information indicating the start position at which a contact body starts to measure an object to be measured in manual measurement; a second acquisition unit that acquires contact position information indicating the contact position at which the contact body and the object to be measured come into contact with each other; a determination unit that determines the direction in which the contact body approaches the object to be measured on the basis of the start position information acquired by the first acquisition unit and the contact position information acquired by the second acquisition unit; and a calculation unit that corrects the contact position information on the basis of the direction determined by the determination unit and thereby calculates the measurement position.

### CROSS REFERENCE TO RELATED APPLICATIONS

This is the U.S. National Phase application of PCT/JP2022/021555, filed May 26, 2022, the disclosure of this application being incorporated herein by reference in its entirety for all purposes.

### FIELD OF THE INVENTION

The present disclosure relates to a numerical control device and a computer-readable storage medium.

### BACKGROUND OF THE INVENTION

Conventionally, a position of a workpiece is measured by a measuring device attached to a spindle of a machine tool (e.g. Patent Literature 1). For example, the position of the workpiece can be measured in a manual mode carried out by an operator by bringing a measuring element into contact with the workpiece. In this case, depending on the approach direction of a contactor to the workpiece, the operator needs to correct coordinate values, which indicate a contact position, in the positive or negative direction by the length of the contactor or the outer diameter of the contactor.

For example, when the contactor approaches the workpiece from the negative to the positive direction, the coordinate values indicating the contact position are corrected in the positive direction by the length of the contactor or the outer diameter of the contactor. On the other hand, when the contactor approaches the workpiece from the positive direction to the negative direction, the coordinate values indicating the contact position are corrected in the negative direction by the length of the contactor or the outer diameter of the contactor. It enables a determination about the precise position of the workpiece.

### Patent Literature

[Patent Literature 1] Japanese Patent Laid-Open Publication No. H5-66820

### SUMMARY OF THE INVENTION

However, if the operator specifies the direction of correction incorrectly, the precise position of the workpiece cannot be determined.

Thus, in the case of measuring the position of the workpiece in the manual mode, there is a need for a technique to automatically specify the direction of correction of the coordinate values indicating the contact position so as to calculate a measurement position.

A numerical control device includes: a first acquisition unit that acquires start position information that indicates a start position where a contact body starts measuring an object to be measured in manual measurement; a second acquisition unit that acquires contact position information that indicates a contact position where the contact body comes into contact with the object to be measured; a determination unit that determines a direction where the contact body approaches the object to be measured based on the start position information acquired by the first acquisition unit and the contact position information acquired by the second acquisition unit; and a calculation unit that corrects the contact position information based on the direction determined by the determination unit so as to calculate a measurement position.

A computer-readable storage medium that stores instructions that cause a computer to execute the following: acquiring start position information that indicates a start position where a contact body starts measuring an object to be measured in manual measurement; acquiring contact position information that indicates a contact position where the contact body comes into contact with the object to be measured; determining a direction where the contact body approaches the object to be measured based on the acquired start position information and the acquired contact position information; and correcting the contact position information based on the determined direction so as to calculate a measurement position.

One aspect of the present disclosure can calculate the measuring position by automatically specifying the direction of correction of the measurement value when measuring the position of the workpiece in the manual mode.

### BRIEF DESCRIPTION OF THE DRAWINGS

FIG. 1 is a block diagram showing an example of a hardware configuration of an industrial machine;

FIG. 2A illustrates a method for calculating a measuring position;

FIG. 2B illustrates another method for calculating the measuring position;

FIG. 3 is a block diagram showing an example of functions of a numerical control device for controlling the industrial machine;

FIG. 4A illustrates an example of a method for acquiring start position information;

FIG. 4B illustrates another example of the method for acquiring the start position information;

FIG. 4C illustrates yet another example of the method for acquiring the start position information;

FIG. 4D illustrates still another example of the method for acquiring the start position information;

FIG. 5 is a flowchart showing an example of processing to be carried out in the numerical control device; and

FIG. 6 is a block diagram showing an example of functions of a numerical control device having a control unit.

A description will now be made about a numerical control device according to an embodiment of the present disclosure by referring to the accompanying drawings. It is to be noted that not all combinations of features described in the following embodiment are necessarily required to solve the problems. In addition to that, unnecessary detailed descriptions may be omitted. Furthermore, the following description about the embodiment and the accompanying drawings are provided to enable those skilled in the art to fully understand the present disclosure, and are not intended to limit the scope of the claims.

The numerical control device is configured to control industrial machines. The industrial machines include, for example, machine tools, a wire electrical discharge machine, an injection molding machine, industrial robots, and a 3-dimensional printer. The machine tools include, for instance, a lathe, a machining center, and a multitasking machine.

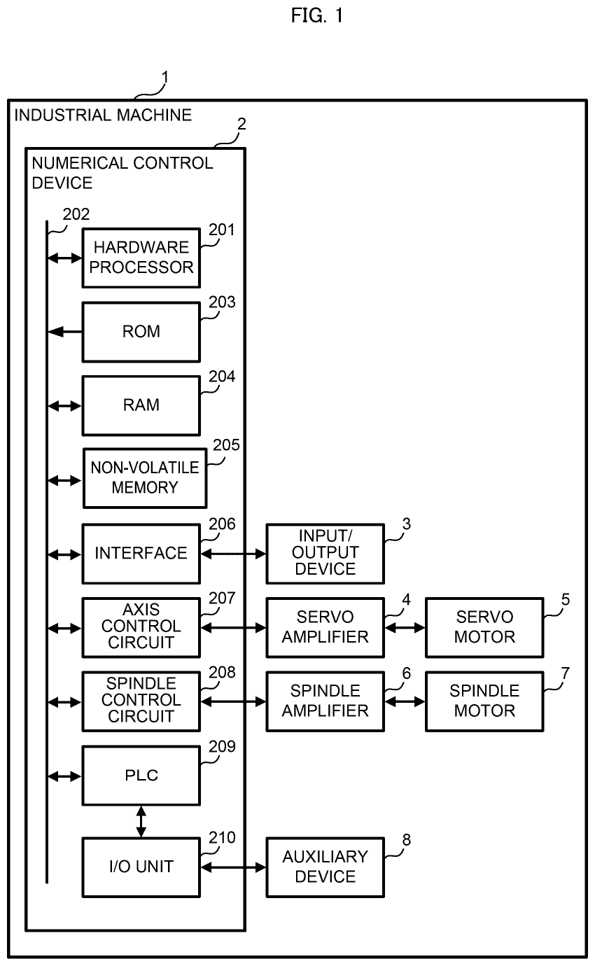

FIG. 1 is a block diagram showing an example of a hardware configuration of an industrial machine equipped with a numerical control device. An industrial machine 1 includes a numerical control device 2, an input/output device 3, a servo amplifier 4, a servo motor 5, a spindle amplifier 6, a spindle motor 7, and an auxiliary device 8.

The numerical control device 2 is configured to control the entire industrial machine 1. The numerical control device 2 includes a hardware processor 201, a bus 202, a read only memory (ROM) 203, a random access memory (RAM) 204, and a non-volatile memory 205.

The hardware processor 201 is configured to control the entire numerical control device 2 according to a system program. The hardware processor 201 reads a system program stored in the ROM 203 through the bus 202 so as to conduct various processes based on the system program. The hardware processor 201 also controls the servo motor 5 and the spindle motor 7 based on an operation program for operating the industrial machine, by way of example. The hardware processor 201 is, for instance, a central processing unit (CPU) or an electronic circuit.

The hardware processor 201 conducts, for example, machining program analysis, and control command output for the servo motor 5 and the spindle motor 7, at each control cycle.

The bus 202 is a communication channel that connects pieces of hardware in the numerical control device 2 one another. The pieces of hardware in the numerical control device 2 exchange data through the bus 202.

The ROM 203 is a storage device that stores a system program for controlling the entire numerical control device 2, for instance. The ROM 203 is a computer-readable storage medium.

The RAM 204 is a storage device that temporarily stores various data. The RAM 204 serves as a work space for processing the various data by the hardware processor 201.

The non-volatile memory 205 is a storage device that can retain pieces of data even when the power of the industrial machine 1 is shut off and thus no power is supplied to the numerical control device 2. The non-volatile memory 205 is configured to store, for example, an operation program and various parameters. The non-volatile memory 205 is a computer-readable storage medium. The non-volatile memory 205 consists of a memory that is backed up by a battery or a solid state drive (SSD), by way of example.

The numerical control device 2 also includes an interface 206, an axis control circuit 207, a spindle control circuit 208, a programmable logic controller (PLC) 209, and an I/O unit 210.

The interface 206 is configured to connect the bus 202 to the input/output device 3. The interface 206 transmits, for instance, various data processed by the hardware processor 201 to the input/output device 3.

The input/output device 3 is configured to receive the various data through the interface 206 and display the data on a display screen. In addition to that, the input/output device 3 accepts the input of various data and transmits the various data via the interface 206 to the hardware processor 201, for instance.

The input/output device 3 is, for instance, a touch panel. For example, the input/output device 3 is a capacitive touch panel. The touch panel is not limited to the capacitive type and may be a different type. The input/output device 3 is installed on a control panel (not shown), in which the numerical control device 2 is accommodated.

The input/output device 3 includes a pulse handle. A pulse handle is a device that generates pulse signals according to the operation conducted by an operator. The hardware processor 201 controls control axes of the industrial machine 1 based on the pulse signals received from the pulse handle.

The axis control circuit 207 is configured to control the servo motor 5. The axis control circuit 207 receives the control commands from the hardware processor 201 and sends various commands for driving the servo motor 5 to the servo amplifier 4. For example, the axis control circuit 207 sends a torque command for controlling torque of the servo motor 5 to the servo amplifier 4.

The servo amplifier 4 is configured to supply a current to the servo motor 5 in response to the command from the axis control circuit 207.

The servo motor 5 is driven upon receiving the current supplied from the servo amplifier 4. The servo motor 5 is provided to each control axis of the industrial machine 1. In a case where the industrial machine 1 is a machine tool having five axes, the servo motor 5 includes, for instance, an X-axis servo motor, a Y-axis servo motor, a Z-axis servo motor, an A-axis servo motor, and a C-axis servo motor.

The servo motor 5 is coupled to, for instance, a ball screw for driving a tool post. When the servo motor 5 is driven, the structure of the industrial machine 1, such as the tool post, is moved in a predetermined controlled axis direction. The servo motor 5 has an encoder incorporated therein (not shown) that detects the position of the controlled axis and a feedrate. Position feedback information and rate feedback information that indicate the position of the controlled axis and the feedrate of the controlled axis, respectively, detected by the encoder are fed back to the axis control circuit 207. The axis control circuit 207 then performs feedback control on the control axis.

The spindle control circuit 208 is configured to control the spindle motor 7. The spindle control circuit 208 sends a command for driving the spindle motor 7 to the spindle amplifier 6 in response to the control command from the hardware processor 201. For example, the spindle control circuit 208 sends a spindle speed command for controlling a rotation speed of the spindle motor 7 to the spindle amplifier 6.

The spindle amplifier 6 is configured to supply a current to the spindle motor 7 in response to the command from the spindle control circuit 208.

The spindle motor 7 is driven upon receiving the current supplied from the spindle amplifier 6. The spindle motor 7 is coupled to a spindle to thereby rotate the spindle.

The PLC 209 is configured to execute a ladder program to control the auxiliary device 8. The PLC 209 sends a command to the auxiliary device 8 via the I/O unit 210.

The I/O unit 210 is an interface that connects the PLC 209 to the auxiliary device 8. The I/O unit 210 transmits the command received from the PLC 209 to the auxiliary device 8.

The auxiliary device 8 is installed in the industrial machine 1, and is configured to conduct auxiliary operations in the industrial machine 1. The auxiliary device 8 operates based on commands received from the I/O unit 210. The auxiliary device 8 may be disposed on the periphery of the industrial machine 1. The auxiliary device 8 is a tool changer, a coolant injection apparatus or an open/closure door drive device, by way of example.

Next, a description will be made about a method for determining a measurement position implemented in the numerical control device 2. The measurement position means a position of a measurement point for an object to be measured. That is to say, it is a position of an object to be measured with which a contact body comes into contact.

In a case of measuring the position of the object to be measured by a manual measurement, the operator brings the contact body into contact with the object to be measured. The manual measurement means that the operator manually measures the position of the object to be measured in a state where the numerical control device 2 is set to the manual mode. The term “manually” means that the operator moves the contact body by using a pulse handle which is connected to the numerical control device 2, for instance, or that the operator moves the contact body by using an axis moving switch of the control panel.

The contact body is a component that is brought into contact with the object to be measured. The contact body is, for instance, a touch probe. The contact body may be a tool, such as an endmill.

The object to be measured is a measurement target in the manual measurement. The object to be measured may be a table on which a workpiece is mounted or a fixture that fixes the workpiece on the table.

In the case of measuring the object to be measured by using the contact body, misalignment by the size of the contact body occurs between the position of the contact body when it comes into contact with the object to be measured and the measurement position of the object to be measured. It is therefore necessary to calculate the measurement position by correcting a value that indicates the position of the contact body when it comes into contact with the object to be measured by using information indicative of the size of the contact body. The position of the contact body when it comes into contact with the object to be measured is a criterial position in the measurement of the object to be measured. The criterial position is referred to as a machine position. The machine position is a position of a control axis in a machine coordinate system. In a case where the industrial machine 1 is a machining center, the machine position is, for example, the position of the end of the spindle and is the position of the central axis of the spindle.

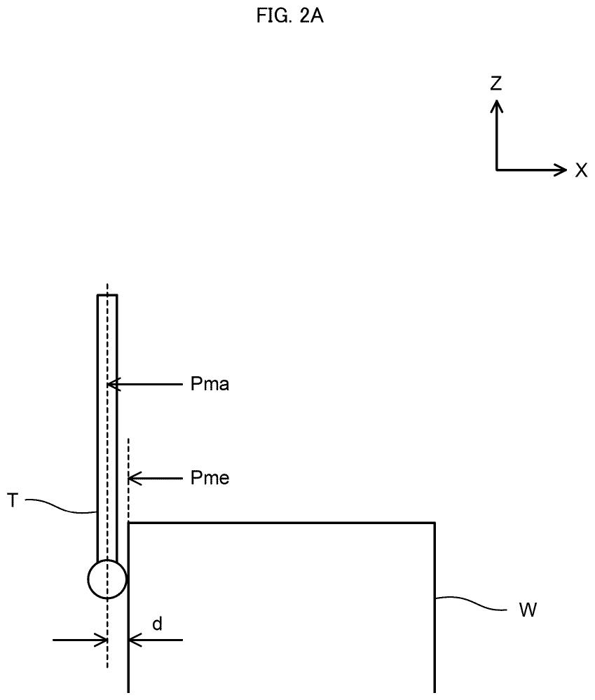

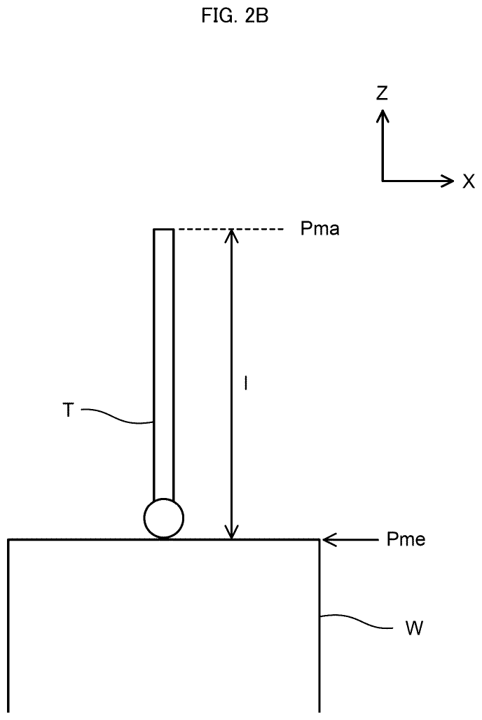

FIGS. 2A and 2B illustrate methods for calculating a measurement position. FIG. 2A shows that a machine position Pma in the x-axis direction is located in the negative direction by the radius d of a contact body T from a measurement position Pme where the contact body T is in contact with an object W to be measured. Thus, as will be described later in detail, in the manual measurement, the numerical control device 2 calculates a position where the machine position Pma is moved in the positive direction by the radius d of the contact body T as the measurement position Pme.

FIG. 2B shows that the machine position Pma in the z-axis direction is located in the positive direction by the length l of a contact body T from the measurement position Pme where the contact body T is in contact with the object W to be measured. Thus, as will be described later in detail, in the manual measurement, the numerical control device 2 calculates, as the measurement position Pme, a position where the machine position Pma is moved in the negative direction by the length I of the contact body T.

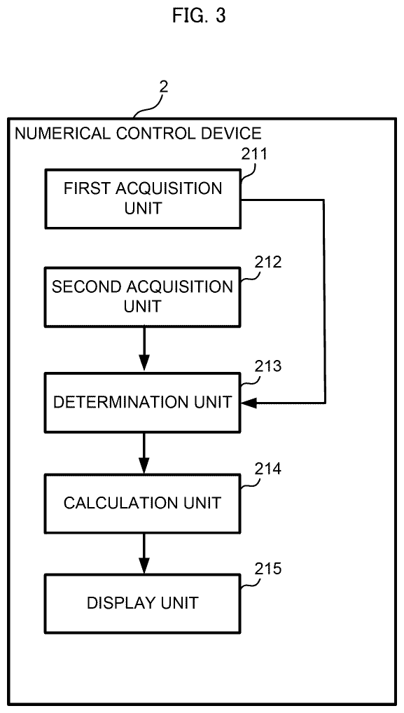

FIG. 3 is a block diagram showing an example of the functions of the numerical control device 2 for controlling the industrial machine 1. The numerical control device 2 includes a first acquisition unit 211, a second acquisition unit 212, a determination unit 213, a calculation unit 214, and a display unit 215. The first acquisition unit 211, the second acquisition unit 212, the determination unit 213, the calculation unit 214, and the display unit 215 are implemented in such a way that, for example, the hardware processor 201 performs arithmetic processing by using a system program stored in the ROM 203 and an operation program stored in the non-volatile memory 205 as well as various data.

The first acquisition unit 211 acquires start position information that indicates a start position where the contact body T starts the measurement of the object W to be measured in the manual measurement. The start position is a criteria position that enables the determination unit 213 to determine a direction where the contact body T approaches the object W to be measured.

The start position is any position between the position of the contact body T when the moving direction of the contact body T is set right before the contact body T reaches a contact position where the contact body T comes into contact with the object W to be measured and the contact position. The start position may be a position of the contact body T when the moving direction of the contact body T is set right before the contact body T reaches the contact position.

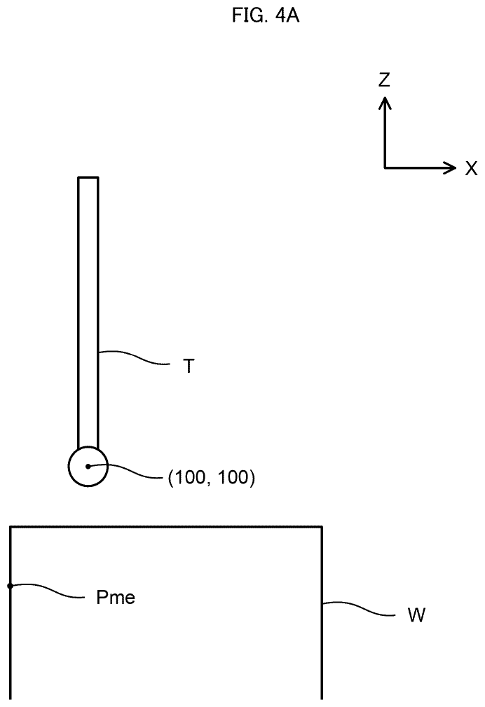

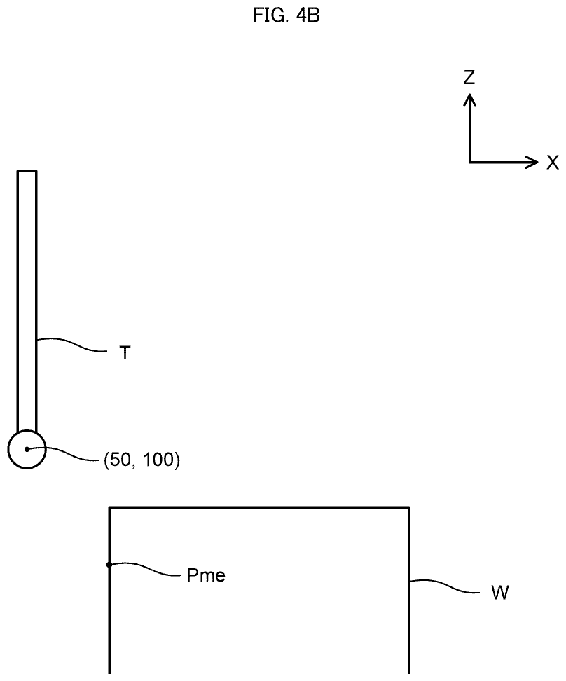

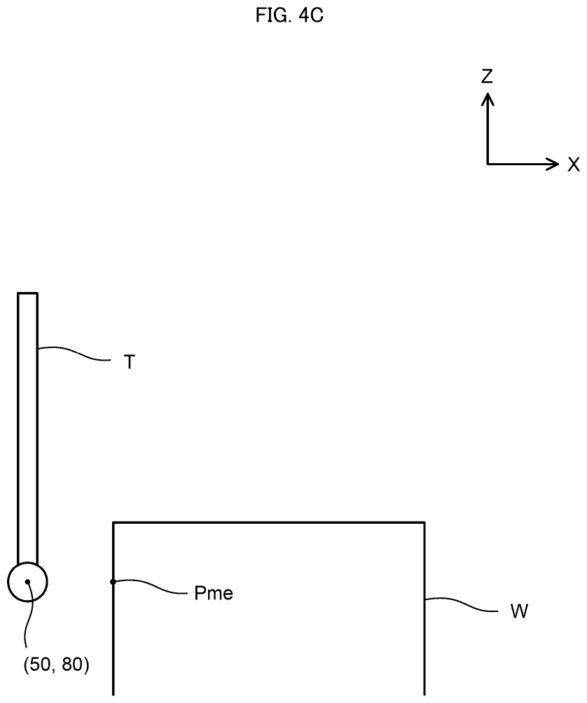

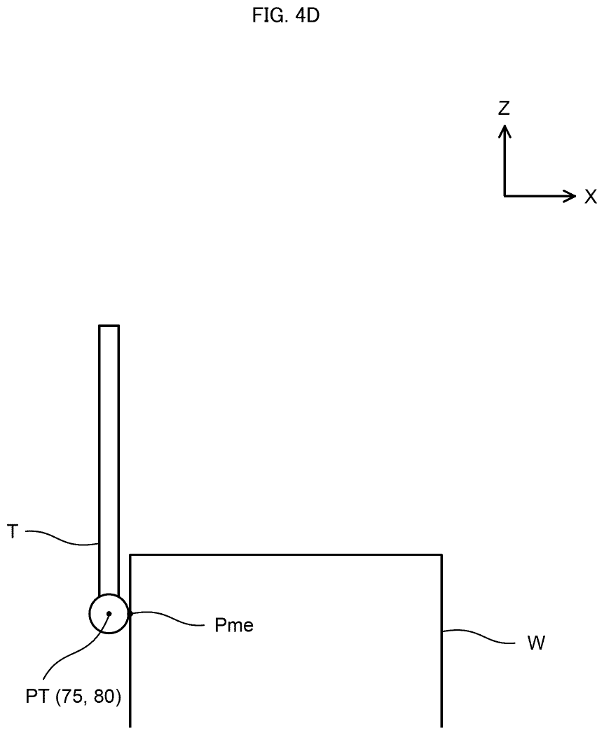

FIGS. 4A to 4D illustrate examples showing how the first acquisition unit 211 acquires the start position information. When measuring coordinate values on the X-axis of the measurement position Pme shown in FIGS. 4A to 4D, the contact body T is firstly arranged in a position in the positive direction of the Z-axis with respect to the object W to be measured. The coordinate values indicating the position of the contact body T at this time are (100, 100), for instance (see FIG. 4A). In order to move the contact body T in the negative direction of the X-axis, the operator conducts the selection of the X-axis in the manual mode. The selection of the axis means selecting a control axis to be moved. For example, the operator selects the X-axis by using an axis changing switch provided on the pulse handle.

In response to the selection of the X-axis, the first acquisition unit 211 acquires the position information of the contact body T based on a signal output from a sensor (not shown) that detects the position of the control axis. In other words, the first acquisition unit 211 acquires information that indicates a position of the contact body T when the moving direction of the contact body T is set to be the axis direction of one control axis among a plurality of control axes. The information indicating the position is, for example, coordinate values. The acquired position information of the contact body T is stored in a predetermined storage area in the non-volatile memory 205, for instance. Then, the operator moves the contact body T in the negative direction of the X-axis by using the pulse handle, by way of example (see FIG. 4B). The coordinate values showing the position of the contact body T at this time are, for example, (50, 100).

The operator in turn conducts the selection of the Z-axis. For example, the operator selects the Z-axis by using the axis changing switch provided on the pulse handle. In response to the selection of the Z-axis, the first acquisition unit 211 acquires the position information of the contact body T to thereby store it in the predetermined storage area.

The first acquisition unit 211 may store newly acquired position information of the contact body T in a storage area where previously acquired position information is stored. In other words, the first acquisition unit 211 may overwrite the previously acquired position information with the newly acquired position information and save it. Alternatively, the first acquisition unit 211 may store the newly acquired position information in a different storage area from the area where the previously acquired position information is stored. The operator then moves the contact body T in the negative direction of the Z-axis (see FIG. 4C). The coordinate values showing the position of the contact body T at this time are (50, 80), for instance.

The operator in turn conducts the selection of the X-axis. In response to the selection of the X-axis, the first acquisition unit 211 acquires the position information of the contact body T to thereby store it in the predetermined storage area.

Then, the operator moves the contact body T to a contact position PT where the contact body T comes into contact with the object W to be measured (see FIG. 4D). The coordinate values showing the contact position PT at this time are, for instance, (75, 80). When the contact body T is moved to the contact position PT, the last position information of the contact body T acquired by the first acquisition unit 211 becomes the start position information. In other words, the latest position information of the contact body T, which is acquired by the first acquisition unit 211 and stored in the predetermined storage area, is the start position information that indicates the start position. In the examples shown in FIGS. 4A to 4D, the coordinate values showing the start position are (50, 80).

The second acquisition unit 212 acquires contact position information that indicates the contact position PT where the contact body T comes into contact with the object W to be measured. The contact position information indicates the position of the control axis when the contact body T comes into contact with the object W to be measured. The second acquisition unit 212 acquires the contact position information based on a signal that indicates that the contact body T has come into contact with the object W to be measured, by way of example.

When the contact body T is a touch probe, the signal indicating that the contact body T has come into contact with the object W to be measured is a signal that is output from the touch probe. For example, when the contact body T is a tool, the signal indicating that the contact body T has come into contact with the object W to be measured is a signal that indicates a load on a control axis that moves the tool. The load on the control axis is determined based on a current value supplied to the servo motor 5, for instance.

The second acquisition unit 212 may acquire the contact position information based on, for example, an operation conducted by the operator on a predetermined operation unit such as a switch (not shown). In this case, the operator conducts the operation on the predetermined operation unit with the contact body T being brought into contact with the object W to be measured.

The determination unit 213 determines the direction where the contact body T approaches the object W to be measured based on the start position information acquired by the first acquisition unit 211 and the contact position information acquired by the second acquisition unit 212.

When the coordinate values of the start position indicated by the start position information are greater than the coordinate values of the contact position PT indicated by the contact position information, the determination unit 213 determines that the direction where the contact body T approaches the object W to be measured is the negative direction. On the other hand, when the coordinate values of the start position indicated by the start position information are equal to or smaller than the coordinate values of the contact position PT indicated by the contact position information, the determination unit 213 determines that the direction where the contact body T approaches the object is the positive direction.

According to the examples in FIGS. 4A to 4D, the coordinate value of the start position on the X-axis indicated by the start position information is equal to or smaller than the coordinate value of the contact position PT on the X-axis indicated by the contact position information, so that the determination unit 213 determines that the direction where the contact body T approaches the object is the positive direction.

The calculation unit 214 corrects the contact position information based on the direction determined by the determination unit 213 to thereby calculate the measurement position Pme. In here, the correction means that a value indicating the size of the contact body T is added to the value indicated by the contact position information to calculate the measurement position Pme, or that the value indicating the size of the contact body T is subtracted from the value indicated by the contact position information to calculate the measurement position Pme. The value indicating the size of the contact body T is, for instance, either a value that indicates the radius d of the contact body T or a value that indicates the length l of the contact body T. The calculation unit 214 may utilize, as a value indicating the size of the contact body T, a value of tool radius correction or a value of tool length correction stored in the numerical control device 2.

In the examples shown in FIGS. 4A to 4D, the direction where the contact body T approaches the object W to be measured is the positive direction. Furthermore, the radius d of the contact body T is, for example, 5 mm. In this case, the determination unit 213 adds a value indicating the radius d of the contact body T to the coordinate value of 75 on the X-axis that indicates the contact position PT so as to calculate the measurement position Pme. In other words, the coordinate value of the measurement position Pme on the X-axis thus calculated is 80.

The display unit 215 displays the information that indicates the measurement position Pme calculated by the calculation unit 214 on a display screen. For example, the display unit 215 displays a pop-up screen on the display screen of the input/output device 3 so as to display the coordinate values indicating the measurement position Pme on the pop-up screen. Thus, the numerical control device 2 can make the operator recognize the position of the object W to be measured.

The display unit 215 may also display the direction of correction of the contact position information on the display screen. For example, in a case where the calculation unit 214 corrects the coordinate values indicating the contact position PT in the negative direction, the display unit 215 displays a letter string “negative direction” on the display screen. In a case where the calculation unit 214 corrects the coordinate values indicating the contact position PT in the positive direction, the display unit 215 displays a letter string “positive direction” on the display screen. Furthermore, the display unit 215 may represent the direction of correction of the contact position information with a figure, such as an arrow.

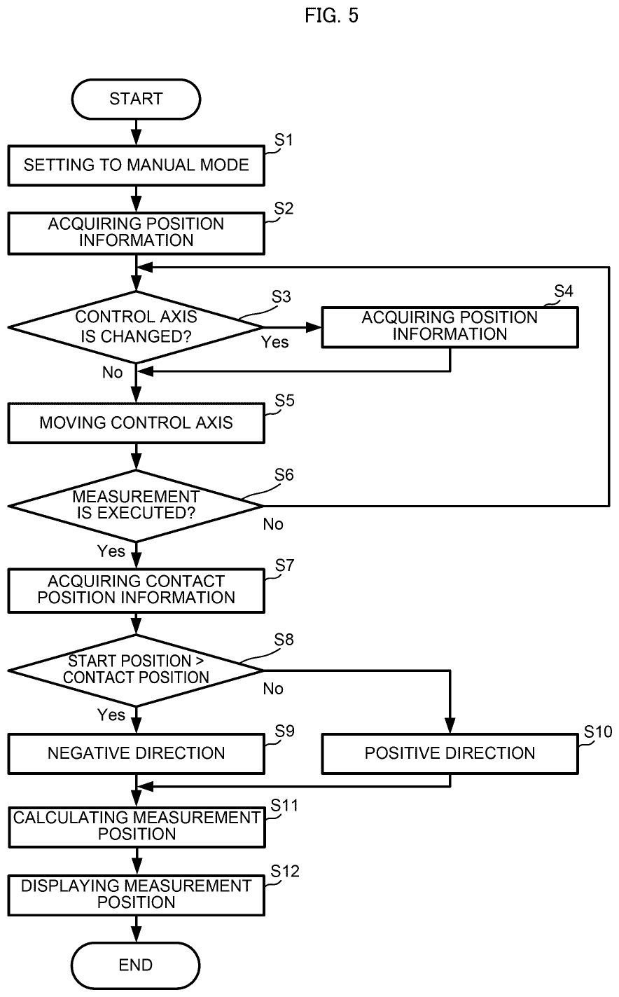

FIG. 5 is a flowchart showing an example of processes to be carried out in the numerical control device 2. In a case of conducting the manual measurement, the numerical control device 2 firstly sets an operation mode to a manual mode according to an operation made by the operator (step S1).

Then, the first acquisition unit 211 acquires information indicating a position of a control axis, and stores the acquired information in a predetermined storage area (step S2). The information indicating the position of the control axis is information that indicates a position of the control axis when the manual mode is set.

Then, based on the operation conducted by the operator, a determination is made about whether or not a control axis to be moved is set (step S3). In other words, it is determined whether or not the control axis to be moved is changed. For example, according to a selection of the X-axis conducted by the operator, the control axis to be moved is set to the X-axis.

When there is no change in the control axis to be moved (when NO in step S3), the numerical control device 2 moves the contact body T according to the control on the pulse handle by the operator (step S5). On the other hand, when the control axis to be moved is changed (when YES in step S3), the first acquisition unit 211 acquires the information that indicates the position of the control axis (step S4). Then, the processing proceeds to step S5.

Next, a determination is made about whether measurement is conducted (step S6). For example, the numerical control device 2 determines about whether or not the measurement is conducted according to whether or not a signal indicating that the contact body T has come into contact with the object W to be measured is received.

When the measurement is not conducted (when NO in step S6), the processing proceeds to step S3 again. When the measurement is conducted (when YES in step S6), the second acquisition unit 212 acquires the contact position information (step S7). When the contact position information is acquired, the information indicating the position of the control axis acquired in step S4 becomes the start position information. In a case where step S4 is not executed, the information indicating the position of the control axis acquired in step S2 becomes the start position information.

Then, the numerical control device 2 compares the coordinate values of the start position indicated in the start position information with the coordinate values of the contact position PT indicated in the contact position information (step S8).

When the coordinate values of the start position are greater than the coordinate values of the contact position PT (when YES in step S8), the determination unit 213 determines that the direction where the contact body T approaches the object W to be measured is the negative direction (step S9). On the other hand, when the coordinate values of the start position are equal to or smaller than the coordinate values of the contact position PT (when NO in step S8), the determination unit 213 determines that the direction where the contact body T approaches the object to be measured is the positive direction (step S10).

Subsequently, the calculation unit 214 calculates a measurement position Pme based on the approach direction (step S11). The display unit 215 in turn displays the measurement position Pme on a display screen (step S12), and the processing is then terminated.

As described above, the numerical control device 2 includes the first acquisition unit 211 that acquires the start position information indicating the start position where the contact body T starts the measurement of the object W to be measured in the manual measurement, the second acquisition unit 212 that acquires the contact position information indicating the contact position PT where the contact body T comes into contact with the object W to be measured, the determination unit 213 that determines the direction where the contact body T approaches the object W to be measured based on the start position information acquired by the first acquisition unit 211 and the contact position information acquired by the second acquisition unit 212, and the calculation unit 214 that corrects the contact position information based on the direction determined by the determination unit 213 to thereby calculate the measurement position Pme.

Thus, when the position of a workpiece is measured in the manual mode, the numerical control device 2 can automatically specify the direction of correction of the coordinate values indicating the contact position PT so as to calculate the measurement position Pme. Consequently, it prevents an operator, who is not familiar with the manual measurement, from incorrectly specifying the direction of correction. In addition, even if the operator causes the contact body T to dig into the object W to be measured accidentally and then returns the contact body T in the direction opposite to the approach direction to the contact position PT, the determination unit 213 determines the approach direction properly. Thus, the calculation unit 214 can calculate a proper measurement position Pme.

Furthermore, the start position is any position between the position of the contact body T when the moving direction of the contact body T is set right before the contact body T reaches the contact position PT and the contact position PT. Thus, the first acquisition unit 211 can acquire the start position information at any timing after the moving direction of the contact body T is set. For example, the first acquisition unit 211 can use, as the start position, a position of the contact body T where the moving speed of the contact body T exceeds a predefined speed after the moving direction of the contact body T is set.

The start position may also be a position of the contact body T where the moving direction of the contact body T is set right before the contact body T reaches the contact position PT. In this case, the first acquisition unit 211 acquires the start position information in response to the moving direction being set.

The second acquisition unit 212 also acquires the contact position information based on a signal that indicates that the contact body T has come into contact with the object W to be measured. The signal indicating that the contact body T has come into contact with the object W to be measured is at least either a signal output by the contact body T or a signal indicating a load on the control axis that moves the contact body T. Thus, the second acquisition unit 212 can automatically acquire the contact position information by the operation conducted by the operator for bringing the contact body T into contact with the object W to be measured. As a result, the operation of the operator in manual measurement is simplified.

The numerical control device 2 further includes the display unit 215 for displaying the direction of correction of the contact position information. Thus, the numerical control device 2 enables the operator to recognize the direction of correction of the contact position information.

The numerical control device 2 may further include a control unit for moving the contact body T to the start position when the second acquisition unit 212 acquires the contact position information.

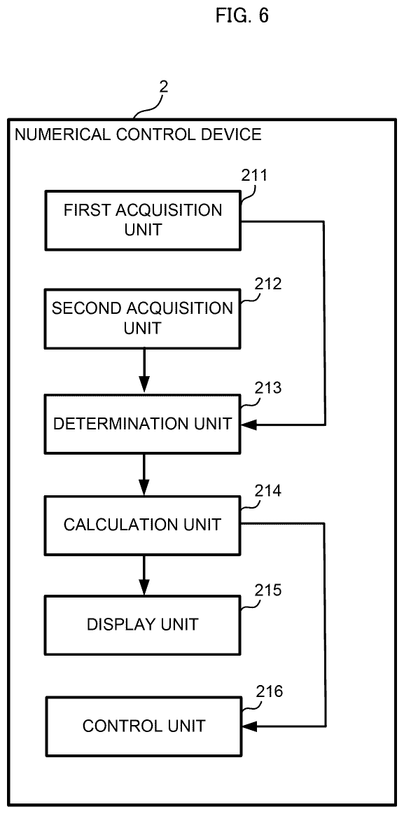

FIG. 6 is a block diagram showing an example of the numerical control device 2 having the control unit. The block diagram shown in FIG. 6 is different from that of the numerical control device 2 shown in FIG. 3 in that the numerical control device 2 includes a control unit 216. Thus, a description will now be made about the control unit 216 and its associated functions, and the functions identical to those described by using FIG. 3 will be omitted.

When the second acquisition unit 212 acquires the contact position information, the control unit 216 moves the contact body T to the start position. Accordingly, the operator does not need to manually return the contact body T to the start position. It prevents the operator from accidentally colliding the contact object T with the object W to be measured. The control unit 216 may operate each control axis of the industrial machine 1 based on a motion program.

The present disclosure is not limited to the above-described embodiments, and can be modified as appropriate without departing from the gist of the invention.

For example, any constitutional elements in the embodiments of the present disclosure can be varied, or any constitutional elements in the embodiments can be omitted.

### REFERENCE SIGNS LIST

1 Industrial Machine
2 Numerical Control Device
201 Hardware Processor
202 Bus
203 ROM
204 RAM
205 Non-Volatile Memory
206 Interface
207 Axis Control Circuit
208 Spindle Control Circuit
209 PLC
210 I/O Unit
211 First Acquisition Unit
212 Second Acquisition Unit
213 Determination Unit
214 Calculation Unit
215 Display Unit
216 Control Unit
3 Input/Output Unit
4 Servo Amplifier
5 Servo Motor
6 Spindle Amplifier
7 Spindle Motor
8 Auxiliary Device
Pma Machine Position
Pme Measurement Position

1. A numerical control device, comprising:
a first acquisition unit that acquires start position information that indicates a start position where a contact body starts measuring an object to be measured in manual measurement;
a second acquisition unit that acquires contact position information that indicates a contact position where the contact body comes into contact with the object to be measured;
a determination unit that determines a direction where the contact body approaches the object to be measured based on the start position information acquired by the first acquisition unit and the contact position information acquired by the second acquisition unit; and
a calculation unit that corrects the contact position information based on the direction determined by the determination unit so as to calculate a measurement position.

2. The numerical control device according to claim 1, wherein the start position is any position between the position of the contact body when a moving direction of the contact body is set right before the contact body reaches the contact position and the contact position.

3. The numerical control device according to claim 1, wherein the start position is the position of the contact body when the moving direction of the contact body is set right before the contact body reaches the contact position.

4. The numerical control device according to claim 1, wherein the second acquisition unit acquires the contact position information based on a signal that indicates that the contact body has come into contact with the object to be measured.

5. The numerical control device according to claim 4, wherein the signal indicating that the contact body has come into contact with the object to be measured is either a signal output from the contact body or a signal that indicates a load on a control axis that moves the contact body.

6. The numerical control device according to claim 1, further comprising a display unit that displays a direction of correction of the contact position information.

7. The numerical control device according to claim 1, further comprising a control unit that moves the contact body to the start position when the second acquisition unit acquires the contact position information.

8. A computer-readable storage medium that stores commands that cause a computer to execute the following:
acquiring start position information that indicates a start position where a contact body starts measuring an object to be measured in manual measurement;
acquiring contact position information that indicates a contact position where the contact body comes into contact with the object to be measured;
determining a direction where the contact body approaches the object to be measured based on the acquired start position information and the acquired contact position information; and
correcting the contact position information based on the determined direction so as to calculate a measurement position.
